(19) United States
(12) Patent Application Publication
(10) Pub. No.: US 2010/0238842 A1
(43) Pub. Date: Sep. 23, 2010

(54) PHONE CONFERENCING ARCHITECTURE WITH OPTIMIZED SERVICES MANAGEMENT

(75) Inventors: Sankaran Narayanan, Redmond, WA (US); Dhigha D. Sekaran, Redmond, WA (US); Dalibor Kukoleca, Redmond, WA (US); Timothy Mark Moore, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/406,974

(22) Filed: Mar. 19, 2009

(51) Int. Cl. H04L 12/16

(52) U.S. Cl. 370/261

(57) ABSTRACT

Architecture that employs a cost-effective mechanism to only engage the services as needed, and then release these services in a managed way. This reduces the runtime cost so that users can have more conferences for the same amount of hardware purchased for such purposes at a minimum cost. The architecture provides the efficient and seamless integration of PSTN phone users and VoIP audio users in a cost effective and efficient way by the use of the same conferencing server and the same audio-video multi-point control unit that users currently employ with additional services that include a conferencing auto attendant service authenticates the phone user and transfers the phone user into the conference, a conference announcement server application is responsible for playing conference announcements, and a personal virtual assistant application which is responsible for translating user-initiated DTMF (dual-tone multi-frequency) tones into conference control commands.

### BACKGROUND

In traditional audio conferencing systems for phone dial-in, audio conferencing services are provided by a dedicated conferencing bridge and there is usually minimal or no integration with other conferencing services or modalities such as voice-over-IP (VoIP). Even if integration is provided, not all services are available for the phone users because the architecture is not sufficiently flexible to accommodate the full range of conference control needed. Alternatively, where services are available, the services are engaged solely for the user and for the extent that the user participates in the conference. However, this can be at enormous expense to the corporation due to dedicated hardware and software, as well as resources to support such systems for dial-in users, for example.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture enables users connecting via the public-switched telephone network (PSTN) to participate in multi-modal conferences hosted by a conferencing system. Moreover, the architecture facilitates this capability using a cost effective mechanism that only engages the services as needed, and then releases these services in a managed way. This reduces the runtime cost so that users (e.g., companies) can have more conferences for the same amount of hardware purchased for such purposes.

Such conferences can be characterized by a heterogeneous mix of clients (e.g., instant messaging (IM), audio, video, application sharing, web conferencing, etc.) including desktop communications software, client phone software for voice-over-IP (VoIP) phones, and users connecting via the PSTN.

The architecture provides at least the efficient and seamless integration of PSTN phone users and VoIP audio users in a cost effective and efficient way by the use of the same conferencing server(s) and the same audio-video multi-point control unit that users currently employ, with the addition of the following components. A conferencing auto attendant service authenticates the phone user and transfers the phone user into the conference. A conference announcement server application is responsible for playing conference announcements. A personal virtual assistant application which is responsible for translating user-initiated DTMF (dual-tone multi-frequency) tones into conference control commands.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented conferencing system in accordance with the disclosed architecture.

FIG. 2 illustrates a more detailed embodiment of a conferencing system for engaging and releasing services for accommodating a PSTN user in a VoIP conference.

FIG. 3 illustrates a call flow diagram for starting a conference for a PSTN user.

FIG. 4 illustrates a call flow diagram for bootstrapping a CAS service into the conference instance.

FIG. 5 illustrates a call-flow diagram for bootstrapping a PVA service into the conference.

FIG. 6 illustrates a conferencing method.

FIG. 7 illustrates alternative aspects of the method of FIG. 6.

FIG. 8 illustrates a block diagram of a computing system operable to execute optimized services engagement and release in accordance with the disclosed architecture.

FIG. 9 illustrates a schematic block diagram of a computing environment for optimized services engagement and release for a PSTN user in a VoIP conference.

### DETAILED DESCRIPTION

The disclosed conferencing architecture provides a cost-effective and seamless mechanism for engaging services only as needed, and then releasing these services in a managed way. This reduces the runtime cost so that users can utilize more conferences for the same amount of hardware/software purchased for such purposes. The architecture at least provides the efficient and seamless integration of PSTN (public-switched telephone network) phone users and VoIP (voice-over-IP) audio users in a cost effective way by using of the same conferencing server and the same audio-video multi-point control unit (AVMCU) that users currently employ, with additional functionality provided by the following services that can be switched in and out: an auto attendant service that authenticates the phone user and transfers the phone user into the conference, an announcement service that plays conference announcements, and a virtual assistant application translates user-initiated DTMF (dual-tone multi-frequency) signals into conference control commands.

Other aspects include a realtime communication and conferencing system that provides presence, telephony and conferencing services using a protocol such as SIP (session initiation protocol), the ability to assign numeric conference identifiers (IDs) and numeric passcodes to a conference, the ability to expose multiple phone lines (including toll and toll-free numbers) which phone users can dial into the conferencing system, and the ability to prompt for the conference ID and conference passcode.

Additional aspects include the ability to lookup a conference given the conference ID, to authenticate the conference passcode in the context of the conference, to join the user into the conference, to play the user's recorded name and entry/exit tones when users join or leave the conference as appropriate, and the ability to receive mute/unmute keys from the user's phone and translate the keys into conference control commands to perform the associated operation as well as to play out to the user via audio that the user has been muted/unmated.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

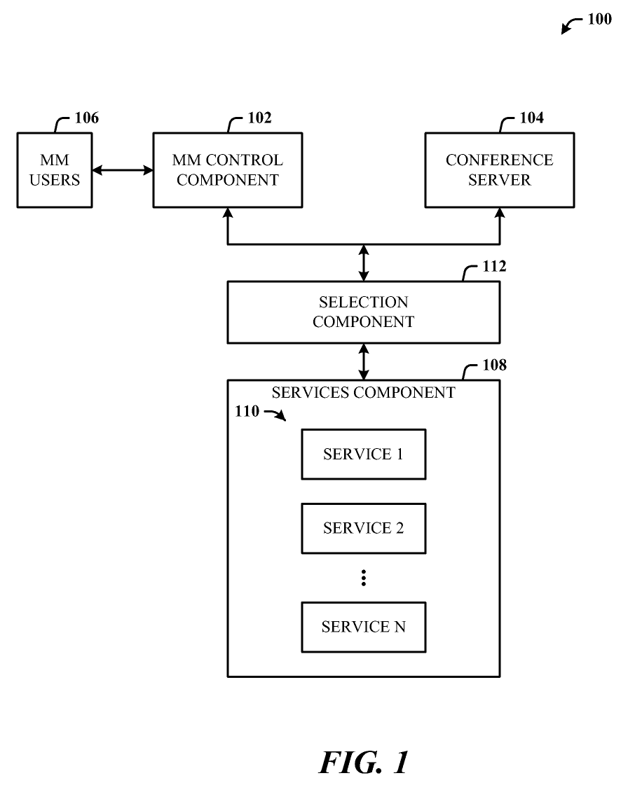

FIG. 1 illustrates a computer-implemented conferencing system 100 in accordance with the disclosed architecture. The system 100 includes a multi-modal (MM) control component 102 and a conference server 104 for enabling multi-modal users 106 to connect to a conference session using multiple different modes of communication. The system 100 also includes a services component 108 for providing one or more services 110 that enable the users 106 to connect and interact during the conference session, and a selection component 112 for individually engaging and releasing the services 110 on an as-needed basis.

The selection component 112 bootstraps one or more of the services 110 into operation in response to bootstrap signals from the control component 102 and/or the conference server 104. The selection component 112 bootstraps one or more of the services 110 into operation to provide access to the conference session (hosted in the control component 102) by a PSTN user. The conference session can also include VoIP participants. The conference server 104 creates and assigns a conference identifier (also referred to herein as session identifier) and a conference passcode (also referred to herein as session passcode) to the session for use by dial-in participants, and the control component 102 exposes multiple phone lines to the audio users for connecting to the session.

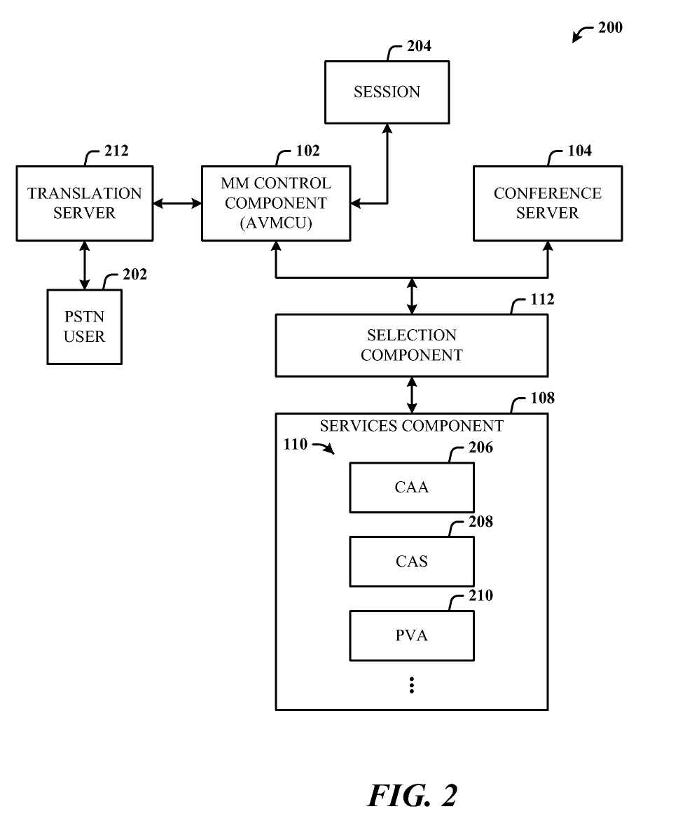

FIG. 2 illustrates a more detailed embodiment of a conferencing system 200 for engaging and releasing services for accommodating a PSTN user 202 in a VoIP conference session 204. In this implementation, the services 110 provided by the component 108 include a conferencing auto attendant (CAA) service 206 that authenticates the PSTN phone user 202 and transfers the PSTN phone user 202 into the session 204, a conference announcement server (CAS) application 208 for playing conference announcements, and a personal virtual assistant (PVA) service 210 for translating user-initiated DTMF signals into conference control commands. Note that other services can be provided to accommodate additional functionality for different types of users participating in the conference.

The CAS service 208 is utilized for a substantial portion if not all of the conference session 204. The PVA service 210 is utilized only for each PSTN user 202 in the conference session 204, yet the PVA service 210 is the most expensive service when employed for processing the DTMF signals of the PSTN users. Thus, if the PVA service 210 is employed to play different audio (e.g., music, tones, etc.) to different PSTN participants the cost quickly escalates. In contrast, if the CAS service 208 is playing the same data to all participants the cost is the same as playing for a single participant. Thus, the CAS service 208 is as expensive as the PVA service 210 when dealing with a single PSTN user. However, if there are fifty PSTN participants in the conference the PVA service 210 is effectively fifty times as expensive, yet only one PVA service is used. So it is a matter of selectively engaging and releasing these services 110 for the conference session 204 in a cost effective and efficient manner. In a more specific implementation, the architecture facilitates the managed engagement and release of the services 110 in a VoIP conference that accommodates PSTN users.

The PSTN user 202 connects through a translation server 212. The translation server translates signaling and media between the PSTN and VoIP clouds. The CAS service 208 prompts the PSTN audio user 202 for a conference identifier and a conference passcode, and the CAA service 206 authenticates the PSTN audio user 202 according to the conference passcode. The CAS service 208 plays a recorded user name of the PSTN audio user 202 when entering and exiting the session 204. The CAS service 208 plays an entry tone when the PSTN audio user 202 enters the session and an exit tone when the PSTN audio user 202 exits the session 204. The session 204 can be searched using a conference identifier. The PVA service 210 processes DTMF signals from the PSTN audio user 202 for mute and unmute functionality relative to participation of the PSTN audio user 202 in the session 204, and the CAS service 208 also plays an announcement to the PSTN user 202 related to the status of the mute and unmute functionality.

The services 110 are not normally needed unless PSTN users participate in the session. In operation, the PSTN user 202 is assigned a PIN that is used to select the conference session 204. When the PSTN user 202 seeks entry to the session 204, the CAA service 206, CAS service 208, and PVA service 210 are assigned for operation with the PSTN user 202. This is tracked in a table in the control component 102 (e.g., an AVMCU). This assignment is tracked in the table for each PSTN user in the session 204, as well as for other session participants.

The CAA service 206 prompts the PSTN user 202 for the PIN, finds the associated conference session 204, hands the user 202 over to the conference session 204, and then backs out of service. In other words, the CAA service 206 accepts the call from PSTN user 202, determines that the PSTN user 202 needs the CAS service 206 and PVA service 210 to participate in the session 204, and then bootstraps the CAS service 206 and PVA service 210 into the session 204. The CAS service 208 is bootstrapped into the session 204 once.

The table inside the control component 102 indicates all the incoming resources (e.g., services 110) and the outgoing endpoints. The control component 102 looks at the table to determine what needs to be done for each participant (endpoint). The PVA service 210 is applied sequentially to each PSTN user coming into the conference. For example, if there are two PSTN users, the PVA service 210 interacts with one PSTN user (and no others) and then the PVA service 210 interacts with the other user (and no others). The table matrix in the control component 102 is extended beyond conventional session information to accommodate the PSTN users.

Put another way, the conferencing system 200 includes the multi-modal control component 102, the conference server 104, and services 110 for enabling PSTN users (e.g., PSTN user 202) to connect to and interact with the conference session 204 (e.g., VoIP), and the selection component 112 for individually engaging and releasing the services 110 on an as-needed basis based on usage by the PSTN users.

The selection component 112 bootstraps one or more of the services 110 into operation in response to signals from at least one of the control component 102 or the conference server 104, and the selection component 112 maintains engagement of an unused service based on a likelihood that the unused service will be needed within a predetermined time. For example, if the session 204 is just getting started, it can be beneficial to maintain engagement of a service since it is likely that another participant, who is a PSTN user, will be dialing-in to the session 204. On the other hand, if it is know that all PSTN users have dialed in, then services 110 can be released when no longer needed.

The services 110 include the CAA service 206 for authenticating the audio users and joining authenticated audio users (e.g., the PSTN user 202) to the conference session as participants, the CAS service 208 for playing announcements to the participants, and the PVA service 210 for translating DTMF signals into control commands that facilitate participant interaction during the session 204. The CAS service 208 prompts an audio user for a conference identifier and a conference passcode and plays an announcement to the audio user about a status of the mute and unmute functionality, the CAA service 206 authenticates the audio user according to the conference passcode, and the PVA service 210 processes DTMF signals from an audio user for mute and unmute functionality relative to participation of the audio user in the session 204. The CAS service 208 plays a recorded user name of the PSTN audio user 202 when entering and exiting the session 204 and an entry tone when the PSTN audio user 202 enters the session and an exit tone when the PSTN audio user 202 exits the session 204.

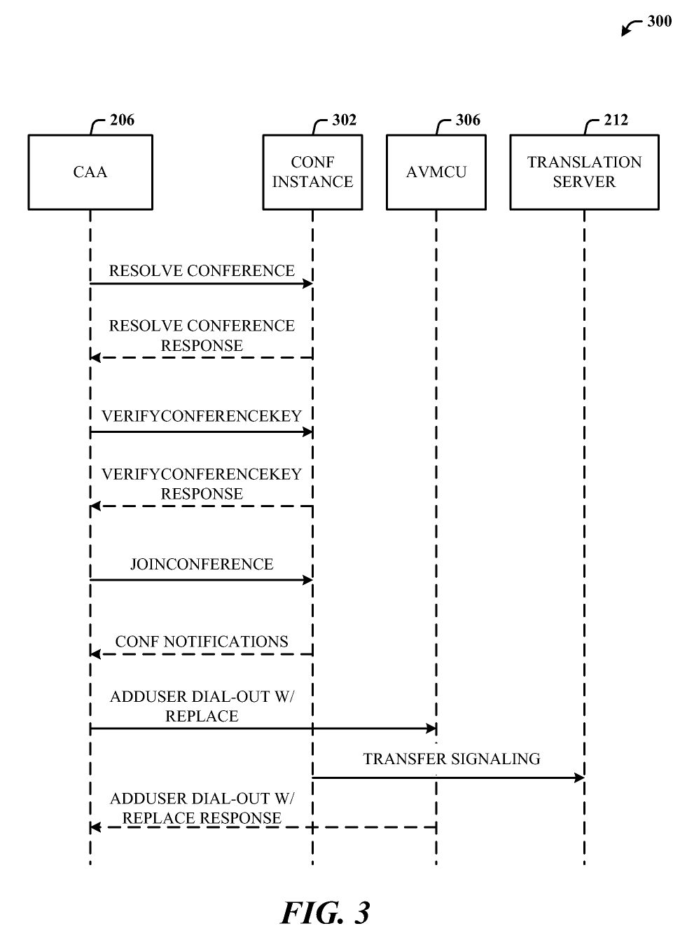

FIG. 3 illustrates a call flow diagram 300 for starting a conference for a PSTN user. When a conference is created (e.g., using an add conference command), a conference instance 302 (a SIP endpoint that represents the conference) issues a conference ID and a conference passcode as part of the conference information, which in turn can be exposed to all users by email or other electronic means (e.g., IM). The instance 302 is responsible for managing the state of the conference, enforcing security, managing roles and privileges and providing conference state updates to the clients, and can run on a frontend server. Along with this, the instance 302 also issues one or more telephone numbers that can be used by the PSTN user to dial-in to the conference. These phone numbers can be provisioned by an administrator and configured to point to the CAA service 206.

A first function performed by the CAA service 206 is to prompt the PSTN user for the conference ID and conference passcode, and then lookup the conference and authenticate the conference passcode. This is shown in the call flow diagram 300. The CAA service 206 first resolves the conference using the supplied conference ID by contacting the conference instance 302. If the resolution was successful, the CAA service 206 is given a conference URI address as a resolved conference response. The CAA service 206 then verifies the conference passcode by invoking a suitable command (e.g., verifyConferenceKey). If the authentication fails, the CAA service 206 announces to the PSTN user that the join failed and for the PSTN user to try again.

If the authentication succeeds, the instance 302 returns a response (e.g., verifyConferenceKey) to the verification command, the CAA service 206 impersonates the PSTN user and then joins (shown as joinConference) the conference instance 302. At this point the PSTN user is part of the conference instance 302 and can receive conference notifications. Conference notifications from the instance 302 to the CAA service 206 supply the list of existing participants (e.g., VoIP users, other PSTN users, etc.) and other conference state information.

The CAA service 206 then sends a command (e.g., addUser) to an AVMCU 306 (e.g., an example of the control component 102) for connecting the PSTN phone user to the audio part of the conference. This is shown as “addUser dial-out w/replace”. This causes the AVMCU 306 to establish a SIP INVITE dialog with the translation server 212 (to which the phone user is already connected) after which the media starts flowing between AVMCU 306 and translation server 212. At this point the user is connected to the conference instance 302 via audio, and hence, the CAA service 206 exits the conference instance 302. The phone user can then be muted by presenters using conference control commands because the user is joined/represented in the same manner as other types of clients.

Upon receipt of the addUser-request-with-replaces semantics the AVMCU 306 performs a SIP INV/200/ACK handshake with translation server 212. The 2000K response contains a gateway tag, which the AVMCU 306 uses to deduce that the user is on the PSTN, and triggers the invocation of the relevant in-conferencing services for this type of user. The AVMCU 306 responds to the addUser request and publishes a notification to the conference instance 302 indicating that the user is connected to the AVMCU 306.

The AVMCU 306 annotates the participant endpoint with the list of in-conferencing services that will be provided for that endpoint, and also a status field for each of the services indicating the current media status. For example, if the PVA service 210 and CAS service 208 are not yet bootstrapped for the user, the associated status for each is set to false.

At this point the CAA service task is done (as the PSTN user has been successfully transferred to the AVMCU 306) and the CAA service 206 can now exit the conference. Note that the CAA service 206 had an instance endpoint for the user and this endpoint goes away when the CAA service 206 exits. However, the user continues to remain in the conference because the user has an endpoint associated with the AVMCU 306.

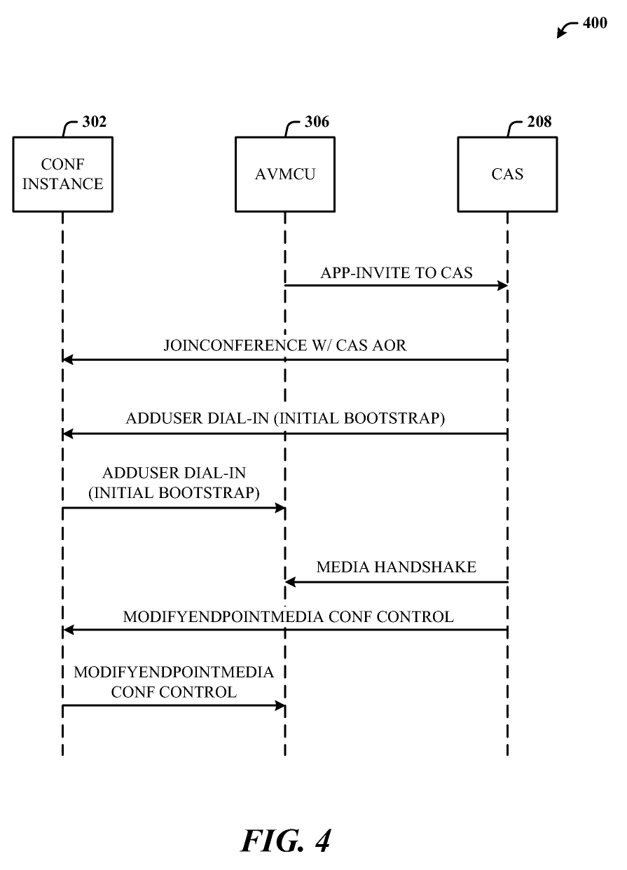

FIG. 4 illustrates a call flow diagram 400 for bootstrapping the CAS service 208 into the conference instance 302. The CAS service 208 is used to send announcements, play recorded names, etc. There is one instance of the CAS service 208 for the whole conference (unlike the PVA service 210 which has one instance per user). The CAS service 208 receives the media-stream from the AVMCU 306 and also sends media-stream to the AVMCU 306 that is broadcasted to all users.

A difference between the CAS service 208 and the PVA service 210 is that the PVA service 210 impersonates users and performs call-control (first-party) for each of the users, while the CAS service 208 performs conference-level operations only. Moreover, it is not necessary for the CAS service 208 to represent a user.

The instance 302 and AVMCU 306 also bootstrap the CAS service 208 into the conference. The CAS service 208 is responsible for playing out conference announcements including general presenter announcements, users who joined or left the conference, etc.

The AVMCU 306 detects that an endpoint (user) is on the PSTN by the fact that the SIP dialog for media is terminated on the translation server 212. The AVMCU 306 can infer this from the presence of the gateway tag in the contact header of the 2000K responses establishing this dialog with the translation server 308. This approach works for both PSTN users that join conferences by dialing in via the CAA service 206 and users on the PSTN that get added through dial-out requests.

Alternatively, PSTN endpoints (users) can join without having a signaling path with the AVMCU 306 that is terminated on a translation server 212. This can be accomplished using a more explicit way of declaring that an endpoint is on the PSTN, and therefore, is provided associated services.

Once the AVMCU 306 has detected that an endpoint is on the PSTN, the AVMCU 306 can do a lookup to discover the address-of-record (AOR) for the associated in-conference services that are utilized. During the installation of the CAS service 208, a mapping table is created to a specific URI/AOR to indicate which server is providing this feature for a pool. A feature can be mapped to multiple AORs for load balancing or high availability.

The AVMCU 306 does this once per conference. The AVMCU 306 can discover whether the CAS service 208 is already active or not from its internal conference state or by querying a conference roster.

As illustrated in FIG. 4, when the conference instance 302 is created on the AVMCU 306, the AVMCU 306 sends an app-INVITE (via SIP) to the CAS service 208. When the CAS service 208 receives the invite, the CAS service 208 then joins the conference instance 302 using its CAS AOR as well as the addUser dial-in command to join the AVMCU 306. It is desirable to have only one CAS service in the conference, which can be triggered into service by the AVMCU 306.

The CAS service 208 also checks to see whether it already has a session for the conference (for which the CAS service 208 received the current app-INVITE). If the CAS service 208 already has an active session, then the CAS service 208 can simply respond to the app-INVITE and continue monitoring changes to the conference roster.

At this point there is a conference session for the CAS service 208 to perform conference control and watch conference state. The CAS service 208 joins as a “trusted user”, and thus, has full privileges to modify existing user sessions as well as perform conference level operations such as full-mute.

When the CAS service 208 receives the first full notification, the CAS service 208 inspects the roster and determines the list of users who need to be wired-in for the service that the CAS service 208 provides.

At this point the CAS service 208 is connected both to the conference instance 302 (to receive all conference state changes) and audio of the AVMCU 306. The CAS service 208 then sends a command (e.g., a modifyEndpointMedia) to be able to send media to all conference users. For the first time, the CAS service 208 sends an addUser dial-in request with the route details. Once the addUser dial-in completes, the CAS service 208 can send a SIP INVITE to the AVMCU conference URI and negotiate the media stream. At this point, the AVMCU 306 is mirroring the media to the CAS service 208. For subsequent users, the CAS service 208 simply uses a command (e.g., a modifyEndpointMedia) to configure the route for each user that the CAS wants to service. Note that the conference control is provided as a trusted user. Whenever a PSTN user enters or exits the conference instance 302, the CAS service 208 can then play tones or recorded names to all users announcing that the user has left the conference.

The AVMCU 306 knows the list of CAS services that can be used for a conference. This can be accomplished by querying the management framework. If multiple CAS URI's are returned, then the AVMCU 306 can select one CAS service and use it for the conference. The CAS services can be deployed as a logical-pool so the initial addressing can be performed on the pool. Subsequent mid-dialog requests can flow based on standard SIP route-set routing.

With respect to high availability, the CAS service 208, the AVMCU 306, or the conference instance 302 can independently fail-over within a conference. The AVMCU 306 can detect CAS service 208 failure by monitoring the RTP (realtime transport protocol) stream. The AVMCU 306 may also receive a notification from the instance 302 indicating that the CAS service 208 has crashed. If the instance roster indicates that the CAS service 208 has lost connection with the instance 302, the AVMCU 306 resets the RTP session. When the AVMCU 306 has thus lost the CAS service 208, the AVMCU 306 bootstraps another CAS service from the pool.

With respect to AVMCU failure, the CAS service 208 can detect AVMCU failure by monitoring the RTP stream, and also receive a notification from the instance 302 indicating that a rollover is in progress. In such cases, the CAS service 208 performs appropriate cleanup action and waits for the AVMCU 306 to rendezvous with the CAS service 208 again.

With respect to failure of the conference instance 302, the conference instance 302 sits behind a load-balancer and frontend losses are usually hidden by the load-balancer. However, if the CAS service 208 detects that the dialog with the instance 302 was lost, the CAS service 208 performs cleanup and waits for the AVMCU 306 to rendezvous back. The CAS service 208 does not perform auto-reconnect because the AVMCU 306 may also be trying to bootstrap a CAS which may or may not be the same CAS service 208. In order to avoid race-conditions where two CAS services get into the conference, a CAS joins the conference only in response to an AVMCU request.

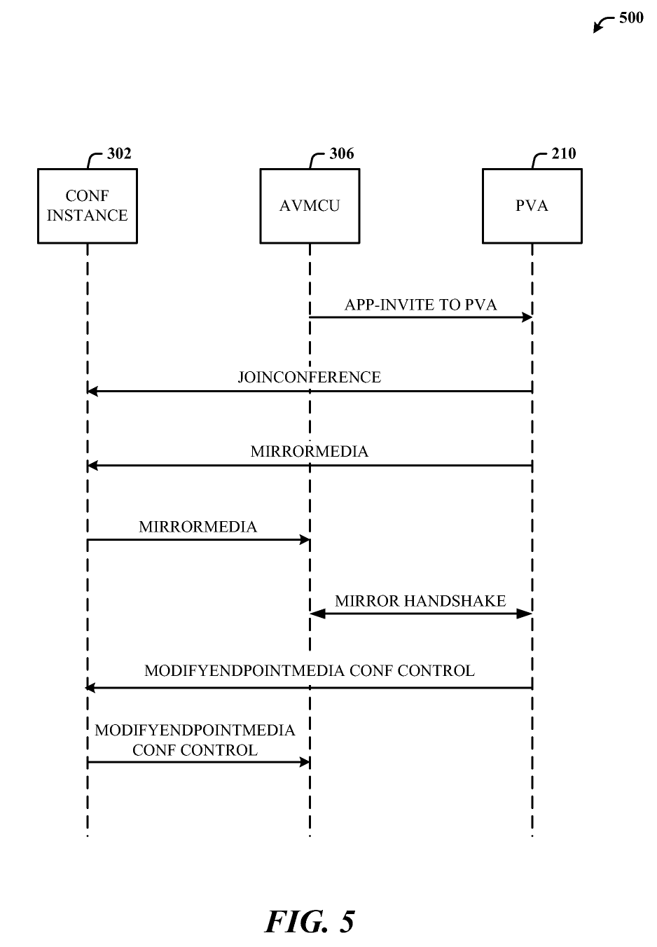

FIG. 5 illustrates a call-flow diagram 500 for bootstrapping the PVA service 210 into the conference. The conference instance 302 and AVMCU 306 can also bootstrap the PVA service 210 into the conference. The AVMCU 306 discovers that PVA service 210 is to be needed as an in-conference service for a PSTN endpoint in a similar fashion as for the CAS service 208. The presence of the gateway tag in the contact header of a 2000K response to an INVITE establishing media streams is used to infer the endpoint requires services associated with PSTN users. The AVMCU 306 therefore looks up the AOR of the PVA service 210.

The AVMCU 306 then sends an app-INVITE to the PVA service 210. When the PVA service 210 receives the app-INVITE the PVA service 210 joins the conference as the user. At this point there is a conference session for the PVA service 210 to perform first-party conference control for this user. The PVA service 210 then sends a modifyEndpointMedia command to the AVMCU 306 to mirror the media of the user to itself. Since the PVA service 210 has already joined the conference, conference authorization at the instance level authorizes this command (this is basically first-party conference control) and sends the command to the AVMCU 306. The AVMCU 306 accepts this command and uses the routing-table definitions supplied in a C3P (centralized conferencing control protocol) request to initiate an outgoing INVITE. The AVMCU 306 already knows the PVA URI being used for this user and sends a standard SIP media-INVITE for the same.

Unlike the CAS service 208 which has only one instance for the whole conference, the PVA service 210 is instantiated once for each user in the conference. The PVA service 210 receives the audio of each user and detects DTMF tones selected by the user. For example, the user may press the mute key on the phone and the corresponding DTMF tone is received by the PVA service 210 in the audio stream. The PVA service 210 then performs the conference control signaling to mute the user.

In the same manner, unmute and other commands can be implemented. If a presenter mutes the user, the PVA service 210 detects the state change and also plays out the corresponding DTMF tone needed to indicate to the phone that the user has been muted. In traditional phones, this results in a phone indictor (e.g., LED) being turned on to indicate the current mute state.

With respect to high availability considerations, the PVA service 210 or the AVMCU 306 can independently fail-over within a conference. The AVMCU 306 can detect PVA failure by monitoring the RTP stream. When the AVMCU 306 has thus lost the PVA service 210, the AVMCU 306 bootstraps another PVA service. The AVMCU 306 also publishes a roster update with the updated endpoint in-conferencing service state indicating that the users are not being provided with PVA service 210. The rest of the reconnect logic happens when the PVA service 210 joins the conference.

The PVA service 210 can detect AVMCU failure by monitoring the RTP stream. The PVA service 210 can also receive a notification from the conference instance 302 indicating that a rollover is in progress. In such cases, the PVA service 210 performs the appropriate cleanup action and waits for the AVMCU 306 to rendezvous with the PVA service 210 again.

The conference instance 302 sits behind a load-balancer and frontend losses are hidden by a load-balancer. However, if the PVA service 210 detects that the dialog with the instance was lost, the PVA service 210 performs cleanup and waits for the AVMCU 306 to rendezvous again. The PVA service 210 does not perform auto-reconnect because the AVMCU 306 may also be trying to bootstrap a PVA service which may or may not be the same PVA service 210. In order to avoid race conditions where two PVA service get into the conference, the PVA service joins the conference only in response to an AVMCU request.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

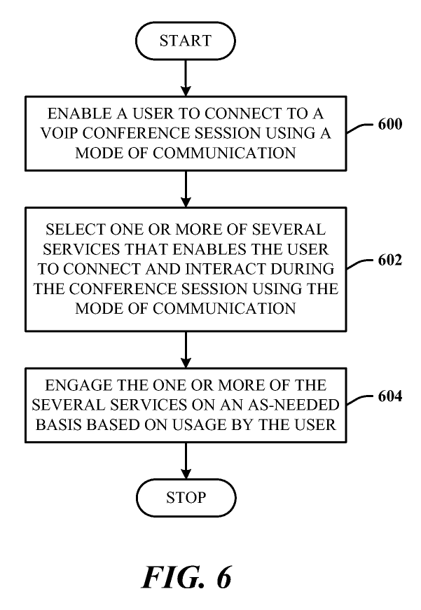

FIG. 6 illustrates a conferencing method. At 600, a user (e.g., PSTN) is enabled to connect to a VoIP conference session using a mode of communications. At 602, one or more of several services is selected that enables the user to connect and interact during the conference session using the mode of communication. At 604, the one or more of the several services is engaged on an as-needed basis based on usage by the user.

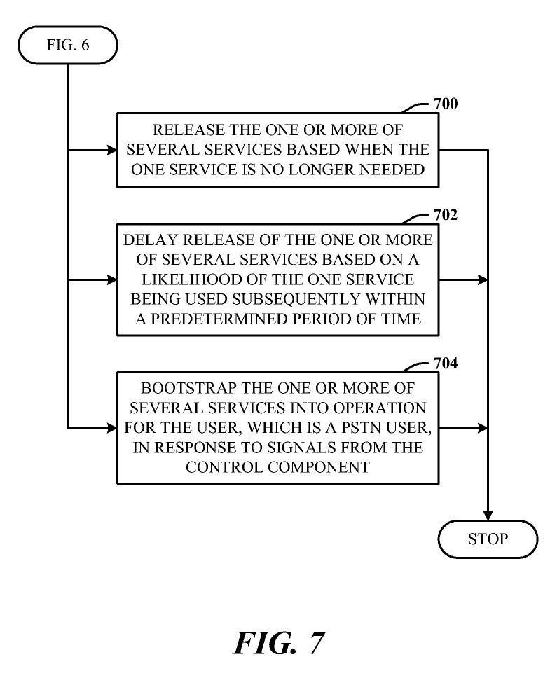

FIG. 7 illustrates alternative aspects of the method of FIG. 6. At 700, one of several services is released based when the one service is no longer needed. At 702, release of the one or more of the several services is delayed based on a likelihood of the one service being used in the future within a predetermined period of time. At 704, the one or more of the several services is bootstrapped into operation for the user, which is a PSTN user, in response to signals from the control component. The services includes at least one of a CAA service for authenticating the audio users and joining authenticated audio users to the conference session as participants, a CAS service for playing announcements to the participants, or a PVA service for translating DTMF signals into control commands that facilitate user interaction during the session.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical, solid state, and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

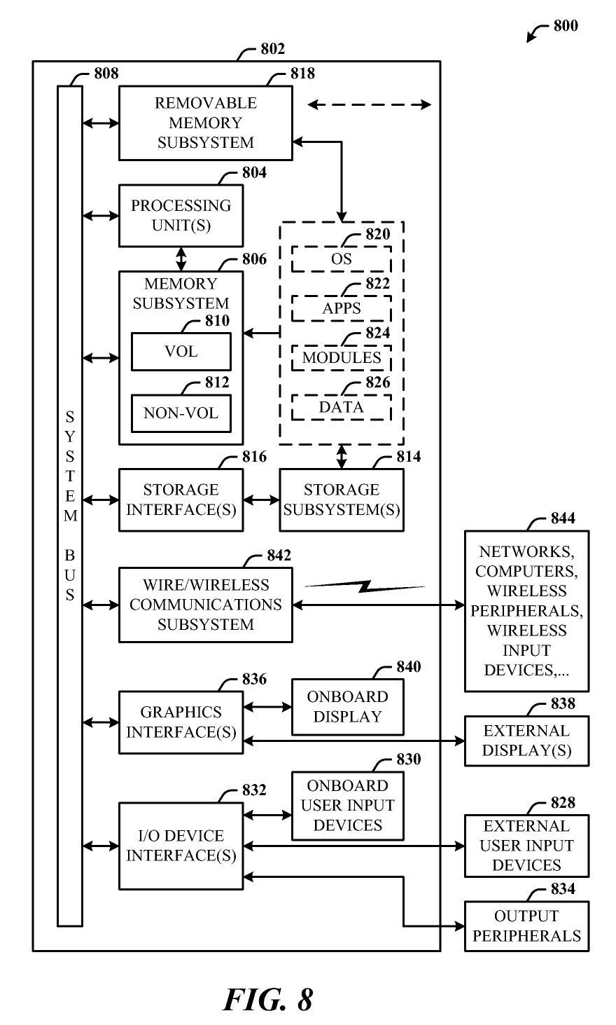

Referring now to FIG. 8, there is illustrated a block diagram of a computing system 800 operable to execute optimized services engagement and release in accordance with the disclosed architecture. In order to provide additional context for various aspects thereof, FIG. 8 and the following discussion are intended to provide a brief, general description of the suitable computing system 800 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 800 for implementing various aspects includes the computer 802 having processing unit(s) 804, a system memory 806, and a system bus 808. The processing unit(s) 804 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 806 can include volatile (VOL) memory 810 (e.g., random access memory (RAM)) and non-volatile memory (NON-VOL) 812 (e.g., ROM, EPROM, EEPROM, etc.). A basic input/output system (BIOS) can be stored in the non-volatile memory 812, and includes the basic routines that facilitate the communication of data and signals between components within the computer 802, such as during startup. The volatile memory 810 can also include a high-speed RAM such as static RAM for caching data.

The system bus 808 provides an interface for system components including, but not limited to, the memory subsystem 806 to the processing unit(s) 804. The system bus 808 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 802 further includes storage subsystem(s) 814 and storage interface(s) 816 for interfacing the storage subsystem(s) 814 to the system bus 808 and other desired computer components. The storage subsystem(s) 814 can include one or more of a hard disk drive (HDD), a magnetic floppy disk drive (FDD), and/or optical disk storage drive (e.g., a CD-ROM drive DVD drive), for example. The storage interface(s) 816 can include interface technologies such as EIDE, ATA, SATA, and IEEE 1394, for example.

One or more programs and data can be stored in the memory subsystem 806, a removable memory subsystem 818 (e.g., flash drive form factor technology), and/or the storage subsystem(s) 814 (e.g., optical, magnetic, solid state), including an operating system 820, one or more application programs 822, other program modules 824, and program data 826. Where the computer 802 is employed as a sever machine, the one or more application programs 822, other program modules 824, and program data 826 can include the components, servers, and services of FIG. 1, the components, servers, and services of FIG. 2, the call flow diagrams 300, 400, and 500 of respective FIGS. 3, 4 and 5, and the methods represented by the flow charts of FIGS. 6 and 7, for example.

Generally, programs include routines, methods, data structures, other software components, etc., that perform particular tasks or implement particular abstract data types. All or portions of the operating system 820, applications 822, modules 824, and/or data 826 can also be cached in memory such as the volatile memory 810, for example. It is to be appreciated that the disclosed architecture can be implemented with various commercially available operating systems or combinations of operating systems (e.g., as virtual machines).

The storage subsystem(s) 814 and memory subsystems (806 and 818) serve as computer readable media for volatile and non-volatile storage of data, data structures, computer-executable instructions, and so forth. Computer readable media can be any available media that can be accessed by the computer 802 and includes volatile and non-volatile media, removable and non-removable media. For the computer 802, the media accommodate the storage of data in any suitable digital format. It should be appreciated by those skilled in the art that other types of computer readable media can be employed such as zip drives, magnetic tape, flash memory cards, cartridges, and the like, for storing computer executable instructions for performing the novel methods of the disclosed architecture.

A user can interact with the computer 802, programs, and data using external user input devices 828 such as a keyboard and a mouse. Other external user input devices 828 can include a microphone, an IR (infrared) remote control, a joystick, a game pad, camera recognition systems, a stylus pen, touch screen, gesture systems (e.g., eye movement, head movement, etc.), and/or the like. The user can interact with the computer 802, programs, and data using onboard user input devices 830 such a touchpad, microphone, keyboard, etc., where the computer 802 is a portable computer, for example. These and other input devices are connected to the processing unit(s) 804 through input/output (I/O) device interface(s) 832 via the system bus 808, but can be connected by other interfaces such as a parallel port, IEEE 1394 serial port, a game port, a USB port, an IR interface, etc. The I/O device interface(s) 832 also facilitate the use of output peripherals 834 such as printers, audio devices, camera devices, and so on, such as a sound card and/or onboard audio processing capability.

One or more graphics interface(s) 836 (also commonly referred to as a graphics processing unit (GPU)) provide graphics and video signals between the computer 802 and external display(s) 838 (e.g., LCD, plasma) and/or onboard displays 840 (e.g., for portable computer). The graphics interface(s) 836 can also be manufactured as part of the computer system board.

The computer 802 can operate in a networked environment (e.g., IP) using logical connections via a wired/wireless communications subsystem 842 to one or more networks and/or other computers. The other computers can include workstations, servers, routers, personal computers, microprocessor-based entertainment appliance, a peer device or other common network node, and typically include many or all of the elements described relative to the computer 802. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 802 connects to the network via a wired/wireless communication subsystem 842 (e.g., a network interface adapter, onboard transceiver subsystem, etc.) to communicate with wired/wireless networks, wired/wireless printers, wired/wireless input devices 844, and so on. The computer 802 can include a modem or has other means for establishing communications over the network. In a networked environment, programs and data relative to the computer 802 can be stored in the remote memory/storage device, as is associated with a distributed system. It will be appreciated that the network connections shown are exemplary and other means of establishing a communications link between the computers can be used.

The computer 802 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

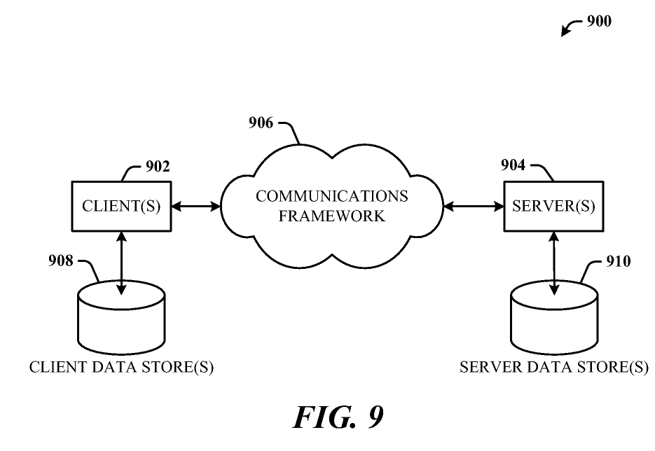

Referring now to FIG. 9, there is illustrated a schematic block diagram of a computing environment 900 for optimized service engagement and release for a PSTN user in a VoIP conference. The environment 900 includes one or more client(s) 902. The client(s) 902 can be hardware and/or software (e.g., threads, processes, computing devices). The client(s) 902 can house cookie(s) and/or associated contextual information, for example.

The environment 900 also includes one or more server(s) 904. The server(s) 904 can also be hardware and/or software (e.g., threads, processes, computing devices). The servers 904 can house threads to perform transformations by employing the architecture, for example. One possible communication between a client 902 and a server 904 can be in the form of a data packet adapted to be transmitted between two or more computer processes. The data packet may include a cookie and/or associated contextual information, for example. The environment 900 includes a communication framework 906 (e.g., a global communication network such as the Internet) that can be employed to facilitate communications between the client(s) 902 and the server(s) 904.

Communications can be facilitated via a wire (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

The clients(s) 902 can be the multimodal users 106 of FIG. 1, the PSTN user 202 of FIG. 2, and the server(s) 904 can include the components, servers, and services of FIG. 1 and FIG. 2, and the functionality represented by the call flow diagrams and methods of FIGS. 3-7, for example.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented conferencing system, comprising:
a multi-modal control component and a conference server for enabling users to connect to a conference session using multiple different modes of communication;
a services component for providing services that enable the users to connect and interact during the conference session; and
a selection component for individually engaging and releasing the services on an as-needed basis.

2. The system of claim 1, wherein the selection component bootstraps one or more of the services into operation in response to signals from at least one of the control component or the conference server.

3. The system of claim 1, wherein the selection component bootstraps one or more of the services into operation to provide access to the conference session by a public-switch telephone network (PSTN) user and for a voice-over-IP (VoIP) session.

4. The system of claim 1, wherein the selection component maintains engagement of an unused service based on likelihood that the unused service will be needed within a predetermined time.

5. The system of claim 1, wherein the services include a conference auto attendant (CAA) service for authenticating the audio users and joining authenticated audio users to the conference session as participants, a conference announcement server (CAS) service for playing announcements to the participants, and a personal virtual assistant (PVA) service for translating dual-tone multi-frequency (DTMF) signals into control commands that facilitate participant interaction during the session.

6. The system of claim 5, wherein the CAS service prompts an audio user for a conference identifier and a conference passcode, and the CAA service authenticates the audio user according to the conference passcode.

7. The system of claim 5, wherein the CAS service plays a recorded user name of a PSTN audio user when entering and exiting the session and an entry tone when a PSTN audio user enters the session and an exit tone when the PSTN audio user exits the session.

8. The system of claim 5, wherein the PVA service processes DTMF signals from an audio user for mute and unmute functionality relative to participation of the audio user in the session.

9. The system of claim 5, wherein the CAS service plays an announcement to the audio user related to status of the mute and unmute functionality.

10. A computer-implemented conferencing system, comprising:
a multi-modal control component and a conference server for enabling PSTN users to connect to a VoIP conference session using multiple different modes of communication;
a services component for providing services that enable the PSTN users to connect and interact during the conference session; and
a selection component for individually engaging and releasing the services on an as-needed basis based on usage by the PSTN users.

11. The system of claim 10, wherein the selection component bootstraps a service into operation in response to signals from at least one of the control component or the conference server, and the selection component maintains engagement of an unused service based on likelihood that the unused service will be needed within a predetermined time.

12. The system of claim 10, wherein the services include a CAA service for authenticating the audio users and joining authenticated audio users to the conference session as participants, a CAS service for playing announcements to the participants, and a PVA service for translating DTMF signals into control commands that facilitate participant interaction during the session.

13. The system of claim 12, wherein the CAS service prompts an audio user for a conference identifier and a conference passcode and plays an announcement to the audio user related to status of the mute and unmute functionality, the CAA service authenticates the audio user according to the conference passcode, and the PVA service processes DTMF signals from an audio user for mute and unmute functionality relative to participation of the audio user in the session.

14. The system of claim 12, wherein the CAS service plays a recorded user name of a PSTN audio user when entering and exiting the session and an entry tone when a PSTN audio user enters the session and an exit tone when the PSTN audio user exits the session.

15. A computer-implemented conferencing method, comprising:
enabling a user to connect to a VoIP conference session using a mode of communication;
selecting one of several services that enables the user to connect and interact during the conference session using the mode of communication; and
engaging the one of several services on an as-needed basis based on usage by the user.

16. The method of claim 15, wherein the user is a PSTN user.

17. The method of claim 15, further comprising releasing the one of several services based when the one service is no longer needed.

18. The method of claim 15, further comprising delaying release of the one of several services based on a likelihood of the one service being used subsequently within a predetermined period of time.

19. The method of claim 15, further comprising bootstrapping the one of several services into operation for the user, which is a PSTN user, in response to signals from a control component.

20. The method of claim 15, wherein the services includes at least one of a CAA service for authenticating the audio users and joining authenticated audio users to the conference session as participants, a CAS service for playing announcements to the participants, or a PVA service for translating DTMF signals into control commands that facilitate user interaction during the session.
